(19) United States
(12) Patent Application Publication
(10) Pub. No.: US 2014/0114832 A1
(43) Pub. Date: Apr. 24, 2014

(54) MULTI-BROKERAGE ACCOUNT MANAGEMENT SYSTEM

(71) Applicant: AccounTrex LLC., Bergenfield, NJ (US)

(72) Inventor: Stephen ESCOTT, Bet Shemesh (IL)

(73) Assignee: AccounTrex LLC., Bergenfield, NJ (US)

(21) Appl. No.: 14/059,488

(22) Filed: Oct. 22, 2013

Related U.S. Application Data
(60) Provisional application No. 61/716,629, filed on Oct. 22, 2012.
(60) Provisional application No. 61/832,992, filed on Jun. 10, 2013.

(51) Int. Cl. G06Q 40/04

(52) U.S. Cl. CPC G06Q 40/04
USPC 705/37

(57) ABSTRACT

A system for managing multi brokerage accounts that allows aggregation among the various accounts of holdings of one or more securities, timing and delivery of cash or securities, cash flow, profit and loss across the accounts, and post-fact tracking of trading strategies. The system accepts inputs and delivers updates based on assumptions of an implemented trading strategy across accounts.

### CROSS REFERENCE TO RELATED APPLICATIONS

This application claims the benefit of U.S. Provisional Patent Application No. 61/716,629, filed on Oct. 22, 2012 and of U.S. Provisional Patent Application No. 61/832,992, filed on Jun. 10, 2013 both of which are incorporated in their entirety herein by reference. This application claims priority to an application filed before Mar. 16, 2013, and contains one or more claims not entitled to a filing date before Mar. 16, 2013.

### BACKGROUND OF THE INVENTION

Stock Funds manage investments for different types of tax entities (“Entities”), such as individuals, partnerships and corporations. One of the most common investment strategies employed by these funds is that of buying stock and subsequently selling those shares at a higher average price. Usually, large Stock funds require that managed entities join a partnership, such that transactions can be carried out in one parent account in the name of the limited partnership, on behalf of the many managed entities. Profits are then distributed by the fund based an entity's percent ownership of that limited partnership.

Some Stock Funds, however, transact by in separate brokerage accounts for each managed entity. This is especially so in the case of funds whose main investment vehicle is the purchase of Initial Public Offerings and Secondary Offerings. In this case, purchasing shares in separate accounts for each managed entity increases the number of shares available for those entities. This in turn increases the profit gained by those entities in cases where those shares are sold at a higher price. Funds that manage investments in this manner are referred to as “Syndicate Trading Funds” (referring to offering underwriters' practice of selling the shares via a syndicate of brokerage firms, thereby increasing the number of shares sold in an offering, which increases the amount of money raised for the corporation raising money via that offering).

For one reason or another, Syndicate Trading Funds typically buy shares in brokerage accounts at one firm while selling those same shares at one or more accounts at another firm. This practice is typically executed with “DVP” (“Delivery Versus Payment”) accounts. Using these accounts, these stock funds transact between different brokers via a centralized securities clearing facility called a “Prime Broker”. Shares are delivered to the fund's Prime Broker account from the purchase account versus automatic payment from the Prime Broker account. The shares are then delivered from the Prime Broker to the account in which the shares were sold, versus automatic payment from that brokerage account back to the Prime Broker in the amount of the sale proceeds. Tracking and managing this activity has been made easier over the last few decades since Prime Brokers, as well as 3^{rd} party software providers that interface with Prime Brokers, typically offer the necessary resident or online accounting systems.

However, in many cases, shares must be purchased in regular, Cash (non-DVP), accounts. This takes place, for example, in the purchase of shares of “non-DVPable” Initial Public Offerings (in which case underwriting firms may elect to restrict allocation of shares to DVP accounts in order to favor the non-institutional “retail investor” community with higher share allocations), regardless of whether or not the stock trader has a Prime Brokerage account or not. Additionally, if a trading firm does not have access to a Prime Broker due to the extremely high account balance requirements (usually $1-$5 million), all trades—without exception—must clear via plain, non-DVP, cash accounts. Until now, no software in existence has effectively assisted in the management and tracking of this activity, due to its highly complicated nature, as well as the small sized market niche that these traders occupy.

The operational complications for this type of trading activity arise due to the manually initiated steps in the purchase, delivery and sale of stock. Before any purchased stock can be delivered, the shares must be settled (paid for) manually by check, direct deposit or bank-wire. Delivery of these shares can then only take place after payment has settled. After settlement, delivery takes place on a “Free” basis (i.e.: not versus payment, or not DVP)—since the shares alone are delivered without any simultaneous automatic money transfers.

While Free Delivery/Receive has been taking place since the dawn of publically traded securities, it has always presented operational and managerial challenges. For one thing, execution of the delivery does not take place automatically. Additional time and work is needed to initiate the share delivery at the first broker, as well as the reception of the shares at the second broker. What makes matters worse is that monitoring and troubleshooting that process is labor intensive and stressful, as problems often surface at or after the delivery deadline, under threat of late-delivery penalties. Most firms are strict about sold shares being delivered into the account by settlement date, while others are willing to wait longer. Regardless, failure to deliver by the Securities and Exchange Commission's imposed limit of thirteen days after trade-date, or “T+13”, results in the account's activity being severely restricted for 90 days.

While many firms deliver shares in an efficient and professional manner, the erratic nature of delivery speed at some firms contributes to the problems mentioned above. While some brokers or firms drag their feet (intentionally or otherwise) for days or weeks getting the shares out the door, others may regularly bungle the share reception, crediting the wrong account, or bouncing them back to the delivering account. When it comes to IPOs (Initial Public Offerings of stock), some firms clamp internal restrictions on when one can deliver stock without being penalized in some way, as IPO underwriters incentivize selling brokers whose clients hold the stock for longer periods of time. These factors encourage the trader to voluntarily delay delivery way beyond t+3 (“trade date plus three” business days, or settlement date)—the day on which it is technically possible to initiate delivery.

The resultant disordered delivery of previously sold stock can make it very hard for a trading firm to predict cash flow, making it almost impossible to decide how much money to set aside for future share purchases. The reason for this is that when stock is sold in a different firm from that in which it was bought, the sale proceeds only become available for use when the shares are received. If trading is heavy, with so many lots of stock being delivered and received by so many brokers on different dates, operations can get bogged down to the point that more time is spent dealing with the delivery issues than actually trading stock. Until now, there has never been a useful way to determine future cash availability in the context of this chaos.

One would think that the above issues would have been solved by now thanks to the many computerized portfolio management systems that are available. Unfortunately, this has not been the case, as even more basic problems persist. Most current systems can't properly account for “multi-account trades”. Even if the trader considers these trades to be part of a single strategy or position, most Portfolio Management Systems do not present an option to affiliate the trades. Instead, they assume that when the trader bought the stock at “Broker A”, he or she intended to have an open “long” position there, and when the trader sold the shares at “Broker B”, it was that trader's intention to maintain a separate open “short” position there. Instead of a realized gain on the actually combined closed position being reported in the program's Profit & Loss Report (“P&L”), no such gain will appear. Instead, no realized gain will be recorded, and two open positions (one “long”, the other “short”) will be shown.

Another problem is the highly complicated process needed to automatically affiliate downloaded inter-account buy/sale and deliver/receive information (most brokerage firms allow the prior day's transaction information to be downloaded for use in financial management software). For example, it could be that 5 lots of 100 shares each of a secondary offering were bought at 5 different brokerage accounts, and sold in two combined lots of 200 and 300 shares at two separate accounts. In this case, it is unclear as to which accounts the separate bought lots were actually sold, and into which sale accounts those bought shares should be delivered. This lack of clarity makes it very difficult to design a computerized system that automatically matches such transactions, and makes it highly impractical and nearly impossible to use any of the existing portfolio management systems for this type of business.

AccounTrex solves these issues by presenting a total solution for any syndicate trading business. By providing the “Blotter” and DealGrid (the Blotter's summary screen), an easy to use framework to record share subscriptions, allocations and sales as they happen, traders themselves enable accurate matching of subsequently downloaded transaction data as they log their trades. Consequently, countless lines of data spanning many accounts are automatically accepted into the database, allowing AccounTrex's Dashboard to accurately reflect a trading firm's global situation whether regarding portfolio, cash availability or stock delivery status. This, together with the system's comprehensive Reporting module, gives the syndicate trader everything needed to trade efficiently in the 21^{st} century.

### BRIEF DESCRIPTION OF THE DRAWINGS

FIG. 1—Blotter screen, with Deal Entry screen

FIG. 2—Ledger Screen

FIG. 3—Rule Management Screen

FIG. 4—Tag Application and Management Screens

FIG. 5—The Dashboard Screen

FIG. 6—The Cash Availability Graph and Table

FIG. 7—Reports Screen

FIG. 8—The Allocations Blotter

FIG. 9—Allocations Blotter Showing Entered Indications and Allocations

FIG. 10—4000 Shares of MSFT Allocated

FIG. 11—Trade Blotter Order Entry

FIG. 12—Trade Blotter Match Trades screen

FIG. 13—Trade Blotter showing Matched and Saved Sale Trade

FIG. 14—Account Setup Screen

FIG. 15—Downloaded Buy Transaction

FIG. 16—Review and Acceptance of Downloaded and Matched Sale Transaction

FIG. 17—Purchased Shares Appear in Portfolio Screen

FIG. 18—Sold Shares Removed from “Open Positions” Screen, and “Portfolio Value” column in the Account Balances Screen. The Position now appears in the “Undelivered Positions” screen.

FIG. 19—Balances Table Popup

FIG. 20—Post Settlement Date Alerts

FIG. 21—Acceptance of Downloaded Wire Transaction Data

FIG. 22—Account Balances Screen Showing Changed Balances After Wire, as well as Overdue Delivery Proceeds

FIG. 23—Downloaded Deliver and Receive Data Before Acceptance Into the Ledger

FIG. 24—Acceptance of Deliver Transaction

FIG. 25—AccounTrex Dashboard upon Complete Settlement of Trade

FIG. 26—P&L Report

FIG. 27—DealGrid

### DETAILED DESCRIPTION OF THE INVENTION

The invention, referred to herein as AccounTrex, is a Portfolio Management System specially designed for stock traders or funds intensively engaged in trading activity that either requires the Free or DVP Delivery of shares from one account to another. A style of trading that typically operates in this way is “Syndicate Calendar Trading”. AccounTrex presents a total solution for any syndicate trading business.

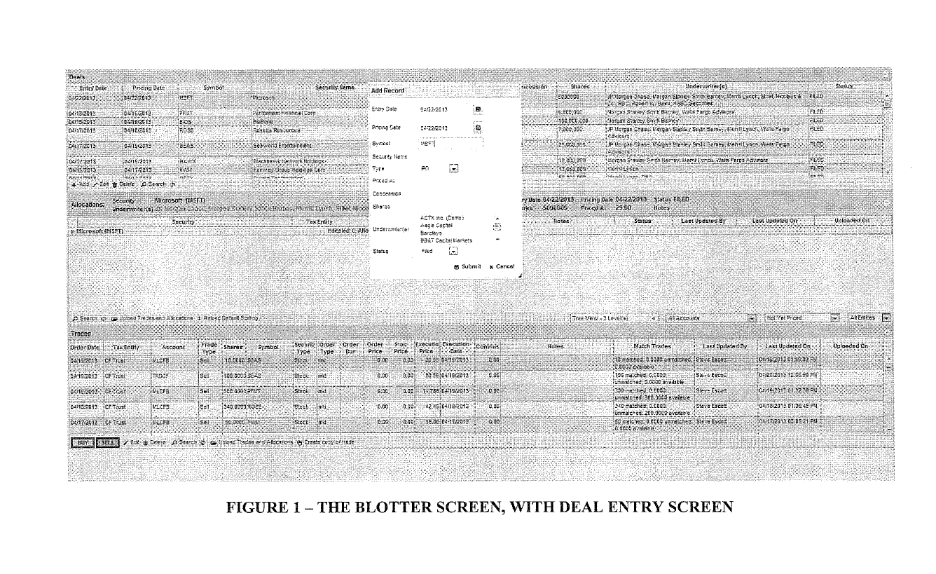

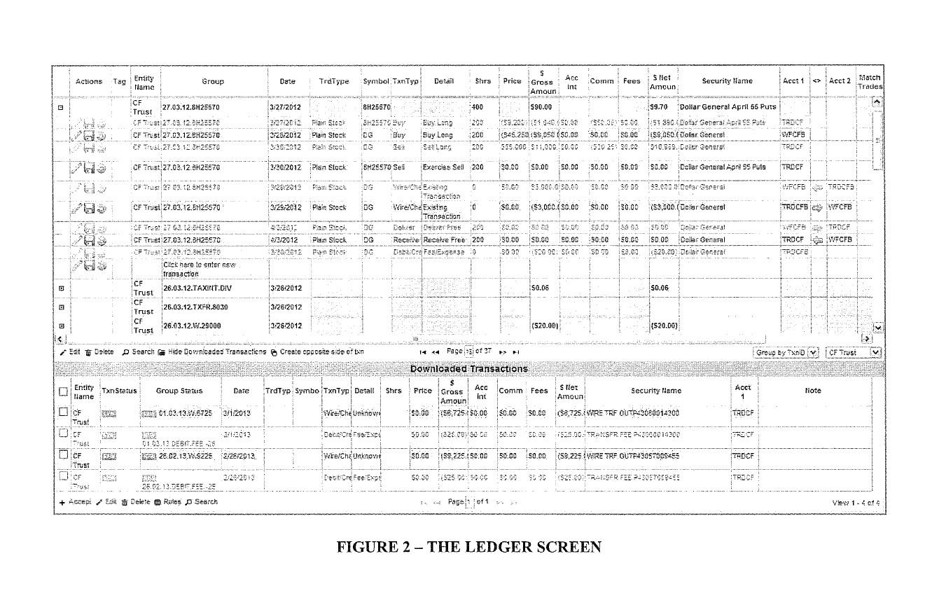

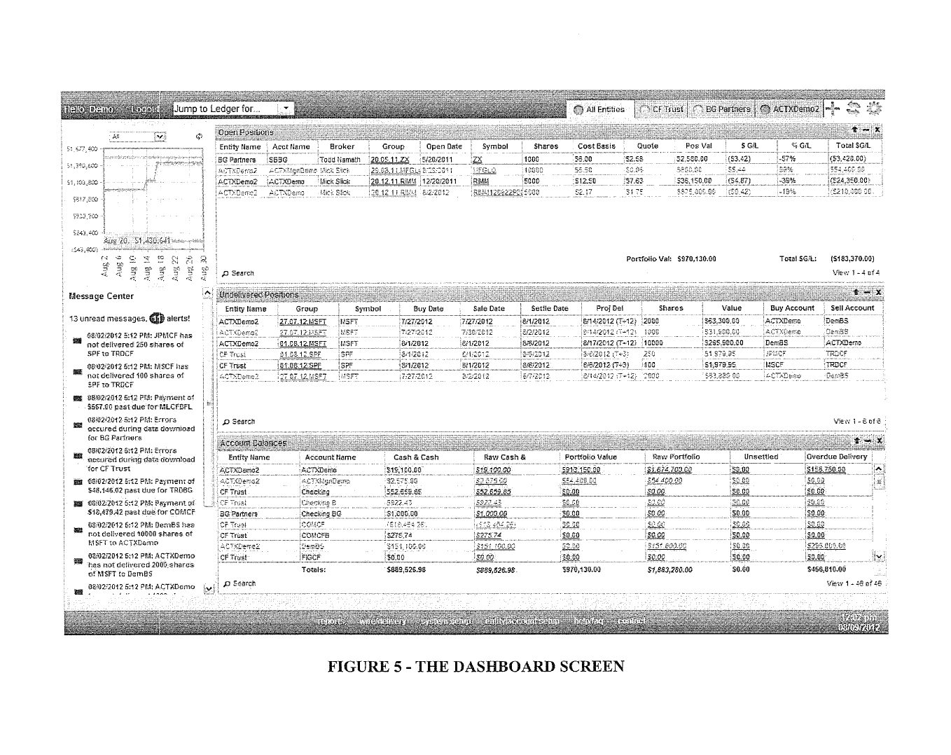

The system's three main screens are:
The Dashboard (FIG. 5), where a manager can view information summarizing the trading business's status
The Ledger (FIG. 2), AccounTrex's main database and data download center, and
The Blotter (FIG. 1), the worksheet into which traders enter their orders and trades as they happen.

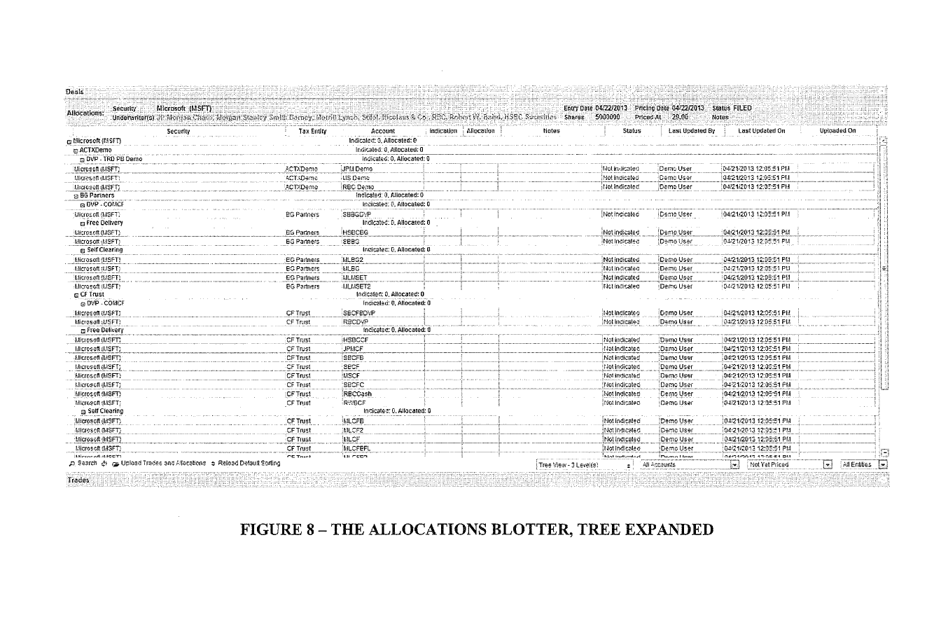

All Stock fund manager and traders log their transactions somewhere, somehow. The AccounTrex Blotter provides an easy to use framework for recording share subscriptions, allocations, sales and money transfers as they happen. In the Allocations Blotter, Offering allocations can be conveniently arranged in a contractible/expandable customizable Tree Structure (FIG. 8), allowing high volumes of data to be viewed in a way that best suites the trader. Allocations can be branched by any combination of Deal, managed Entity, and by Clearance Method (ie: Free Delivery allocations, DVP allocations, Self Clearing (not for delivery) allocations).

By logging their transactions in the Blotter, Stock Fund managers and traders themselves unconsciously enable accurate matching of huge quantities of subsequently downloaded transaction data. For Consequently, countless lines of data spanning many accounts are automatically accepted into the database, matched and paired with their affiliated transactions and accounts. This process easily and conveniently allows AccounTrex's Dashboard to accurately reflect a trading firm's global situation whether regarding portfolio, cash availability or stock delivery status. Together with the system's comprehensive Reporting module, the syndicate trader has everything needed to efficiently manage his trading business.

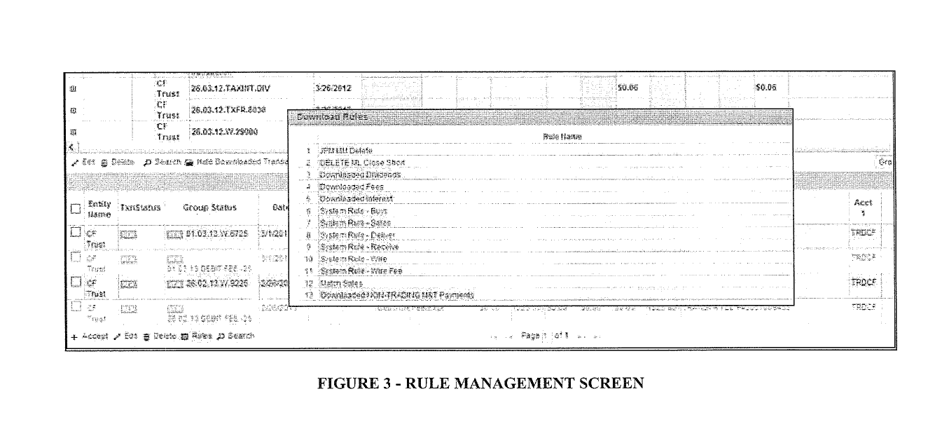

In entering a sale of shares into the “Trade Blotter”, that sale is matched by the trader with the specific buy lot(s) that are being sold, which the trader intends to deliver against the sale. Matching to the sale can take place whether the bought shares exist in the Allocations Blotter (because they were just bought on a stock offering), The Trade Blotter (because they were just bought in a regular open market transaction), or the Ledger—AccounTrex's historical transaction database compiled from confirmed transaction downloads via the trader's brokerage accounts. While not mandatory in the Blotter, matching there helps to sharpen the accuracy of the automatic trade matching that occurs using the Downloaded Transaction Screen's Automatic Data Acceptance Rules after the transactions are downloaded. AccounTrex automatically downloads transactions from brokerage accounts into the Downloaded Transactions Screen, which can then be either manually accepted into the Ledger, or automatically accepted into the Ledger via AccounTrex Automatic Data Acceptance Rule System, or “Rules” (FIG. 3). Transactions whose confirmations have not been downloaded can be manually entered into the Ledger as well.

Regardless of how data is entered into the Ledger, AccounTrex gives the trader the option to affiliate trades or other securities related transactions (such as stock deliveries or receives) by placing them in unified “Transaction Groups” within the Ledger screen (See FIG. 2, which shows Transaction Group 27.03.12.8H25570, consisting of the purchase and sale of DG shares, as well as the purchase and exercise of related Stock Options). During or after transaction acceptance, transactions within a transaction group that are specifically affiliated with each other, such as a sale of certain specific buy lots, or a delivery of certain bought shares, are further “Matched” to their source transactions (the sale to its buy lots, the delivery to its bought shares). While Grouping and Matching is accomplished via Rules, those tasks can be done manually as well.

Transaction Groups also allow the grouping of trades that are relevant to a particular trading or hedging strategy to produce a single profit/loss figure, even if those trades have taken place with different security types (such as Stocks and their affiliated Options), at different times, or at different firms.

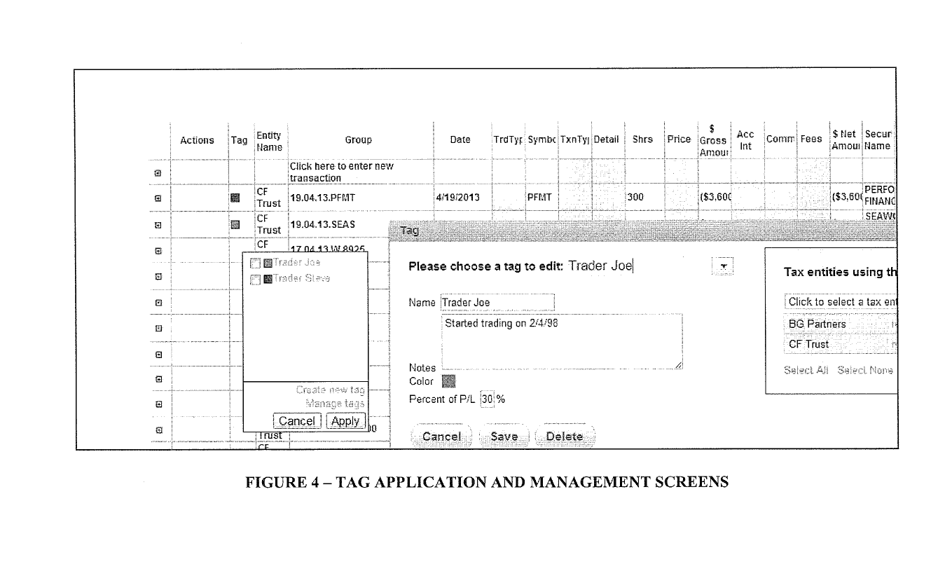

After acceptance into the Ledger, transactions can also be grouped for inclusion in filtered profit/loss reports using the Tagging feature (See FIG. 4). Tagging allows users of AccounTrex to apply text and color tags to any transaction or transaction group. Profit/Loss reports can then be generated showing the performance of transactions bearing a given tag. This feature can be quite helpful to trading firms analyzing the profitability of various strategies. It can also help firms that pay their traders based on each trader's personal performance. If trades are tagged as belonging to a particular trader, that trader's performance can be rapidly analyzed by generating a Profit/Loss report filtered by his tag.

The transaction data can be analyzed via tables, graphs and alerts on the “Dashboard” (see FIG. 5), AccounTrex's main screen. This facilitates a stock trading fund's highly efficient monitoring of portfolio holdings, stock delivery and money balances. The Dashboard presents a trading fund's status in an orderly and timely fashion, significantly reducing the ill effects of bad stock delivery or errant money transfer execution by immediately calling those faults to the Trader's attention.

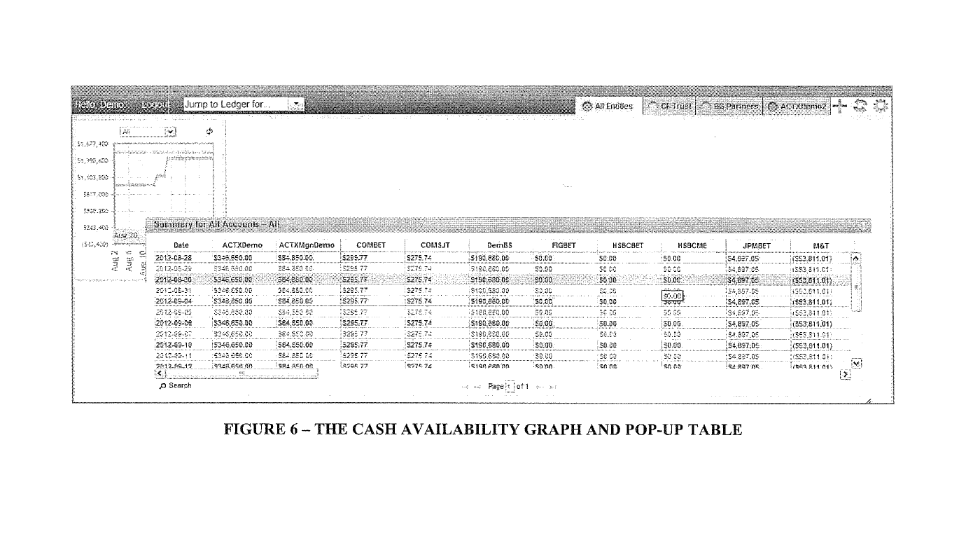

While AccounTrex does troubleshoot the errors of the past (through reports and dashboard screens that reveal mismatched or unauthorized trades, late deliveries, and missed wire payments) as well as accurately monitor current status, the system also helps a trading business proceed into the future with higher efficiency. For instance, a highly unique feature of AccounTrex is its ability to forecast each account's cash position by simulating upcoming trade settlement and delivery using that account's historical stock delivery speed. Delivery speed is visible in each account's setup screen, entered either manually (based on the user's estimation) or automatically based on average historical delivery time. Combining this information with the record of each account's recent unsettled trades found in AccounTrex's transaction Ledger, the future cash position forecast can be made, appearing in the form of the Dashboard's Cash Availability Graph and Table (See FIG. 6). The table displays what each account's projected cash availability will be on any date for the next 30 days, taking that account's recent unsettled trades into account. The Graph summarizes that information, showing total cash availability for any tax entity across all of that entity's accounts. Predicting what a fund's total cash position will be in the future allows a manager to subscribe to future securities offerings with an accurate idea as to how many shares or deals at a time the fund could handle. Without such a forecast, the manager may subscribe for too many shares, causing a cash flow crisis if those shares are actually allocated to the fund. Or, alternatively, a smaller number of shares will be subscribed for, while the fund could have afforded to take on a larger position.

In order to cater to the needs of multi-client investment managers, the AccounTrex Dashboard is designed to clearly present data for multiple tax entities. Each individual client's data can be viewed via its own “Entity” tab, and all client data can be combined and viewed together on the Dashboard via the “All Entities” tab. The tabs are found on the top right corner of the Dashboard (see FIG. 5).

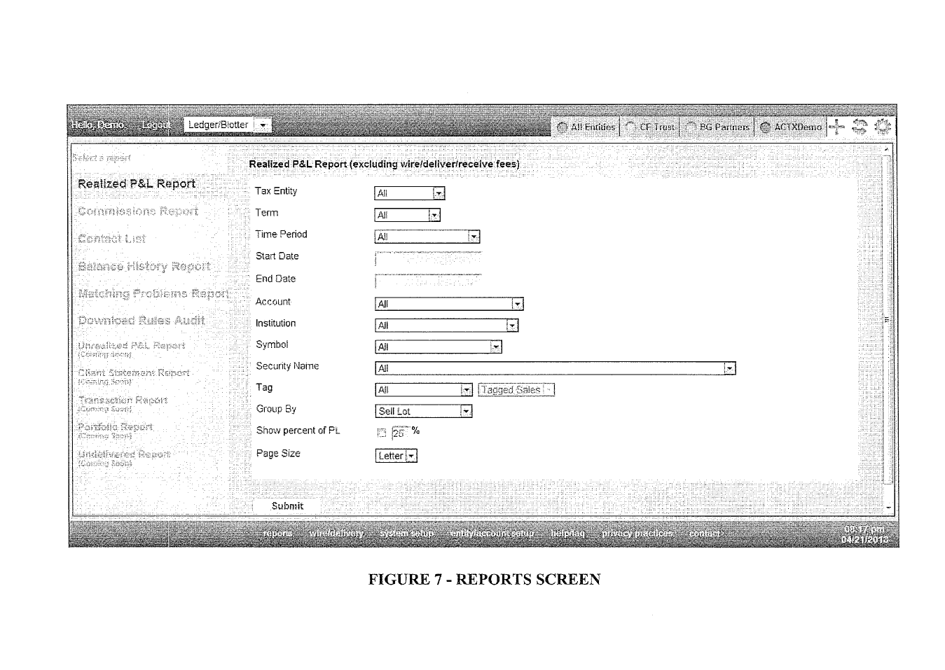

Typical Portfolio Management reports (Realized and Unrealized P&L, Dividends and Interest, etc.) are available in the “Reports” screen (see FIG. 7), and can be filtered by date, period, account, brokerage firm, security, or tag. P&L Reports can also be displayed in different groupings: Sale Lot (preferred for IRS filings), Buy Lot (displays allocation performance of buy-side brokers), Transaction Group ID, or Tags. Additional reports such as Contact List (providing an up to date list of broker names, numbers and addresses), and reports unique to AccounTrex, analyzing account activity are available on that screen as well. These include Commissions Report and Balance History Report. Commissions Report analyzes and compares gross P&L generated by a broker against commissions paid to that broker for regular trades, as well as new or secondary offerings. Reports that analyze data integrity are also accessible via the Reports screen, such as the Matching Problems Report, and the Download Rules Audit Report shows details regarding how the Download Rules were actually applied to downloaded transactions.

AccounTrex-Enterprise is a version of the system that allows larger Trading Funds to operate efficiently. In this scenario, A fund's senior managers have fully functioning AccounTrex logins, providing them with access to all of the system's features. Non-management level traders/employees login to the more limited “AccounTrex-Trader. This version allows access to Trader Specific Blotters, a read only version of the Ledger, and limited P&L reporting. In this way, Traders can enter their share allocations and trades, as well as view previous trade history and their personal P&L in a cost effective manner. Management retains full read/write access to all fund-wide transactions, as well as having access to an expanded suite of reports, including a Trader Performance Comparison report.

An analysis of a typical transaction will illustrate how the Ledger works together with the Blotters and the Dashboard.

A Typical Transaction

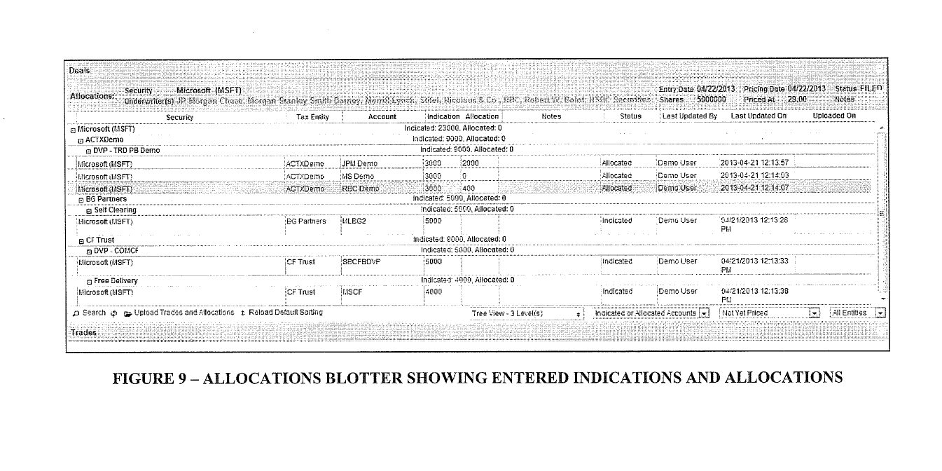

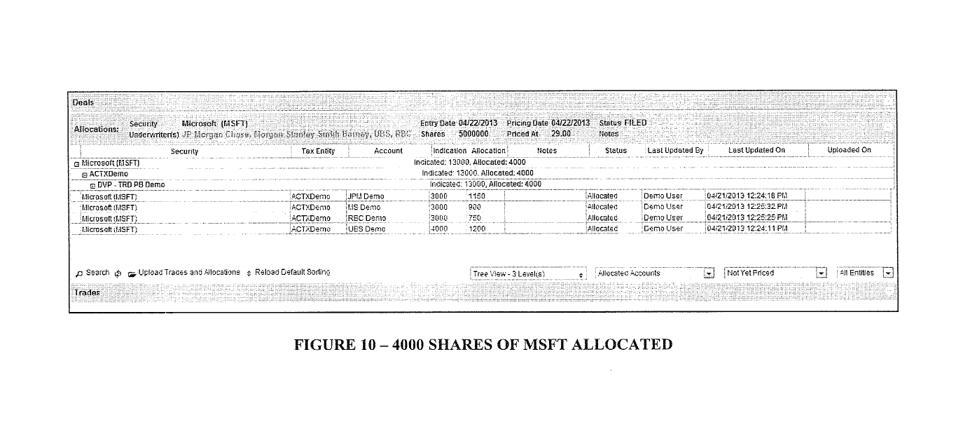

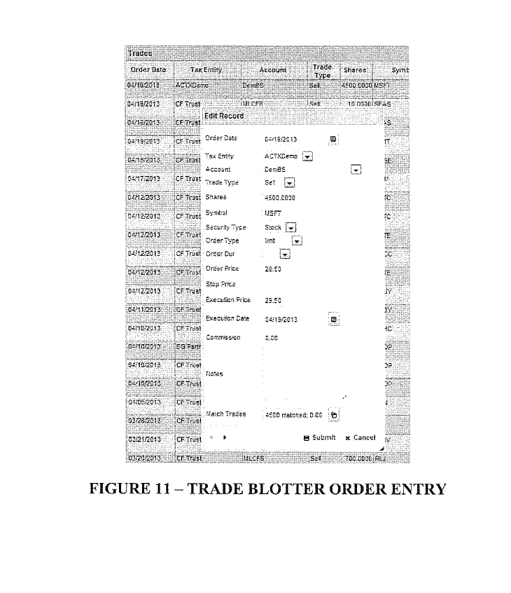

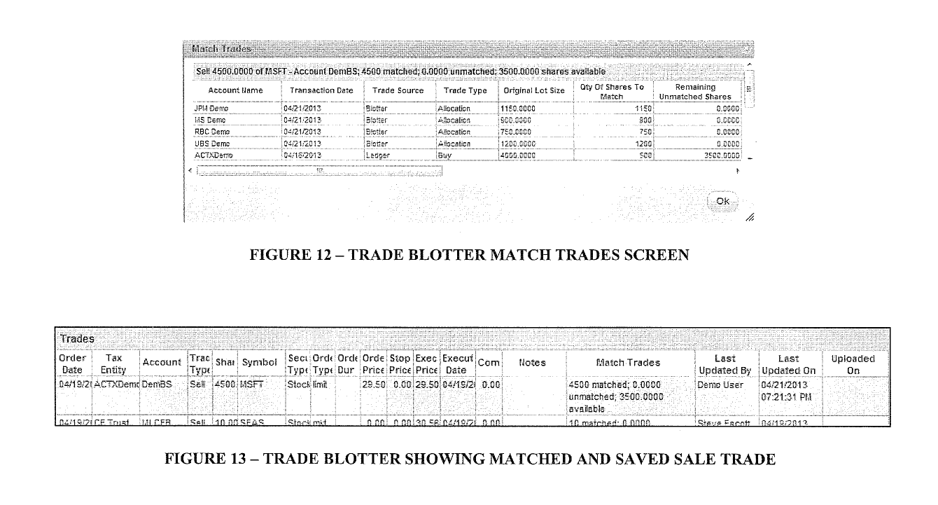

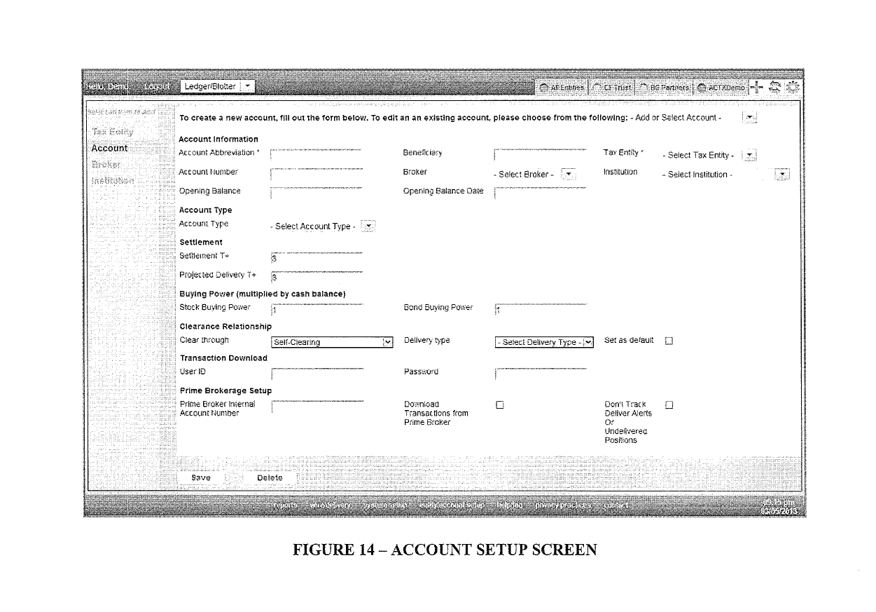

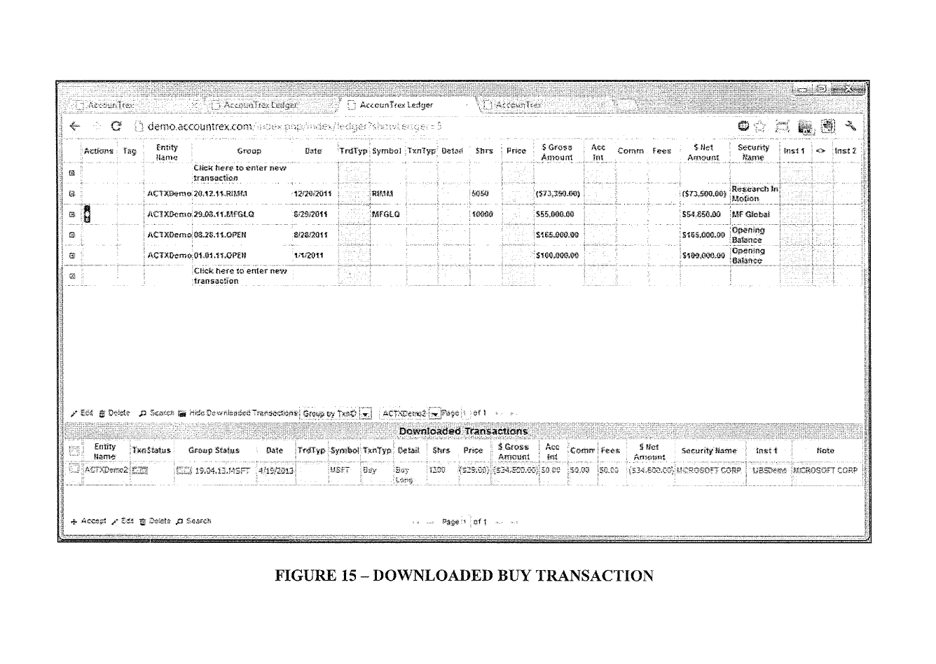

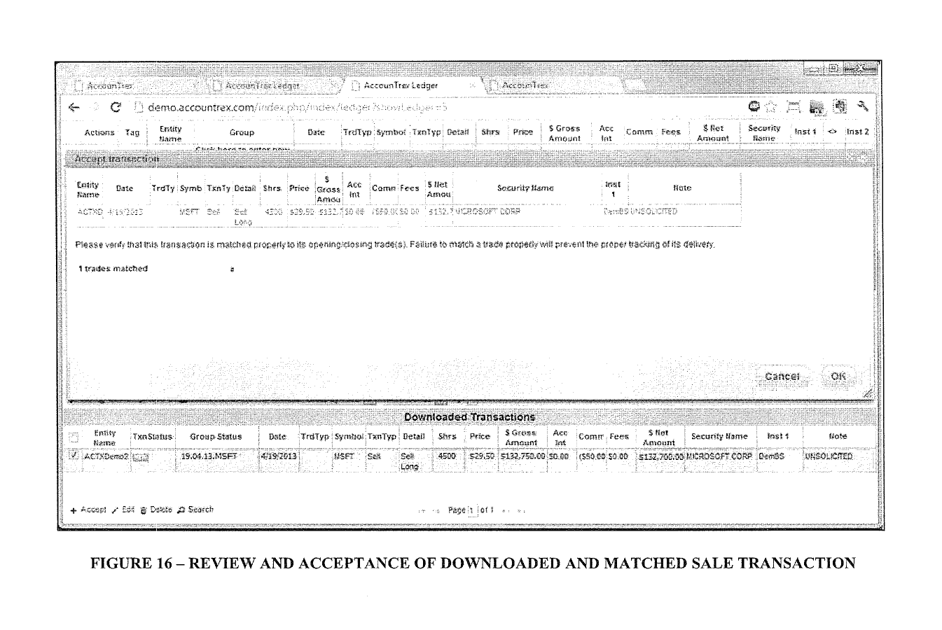

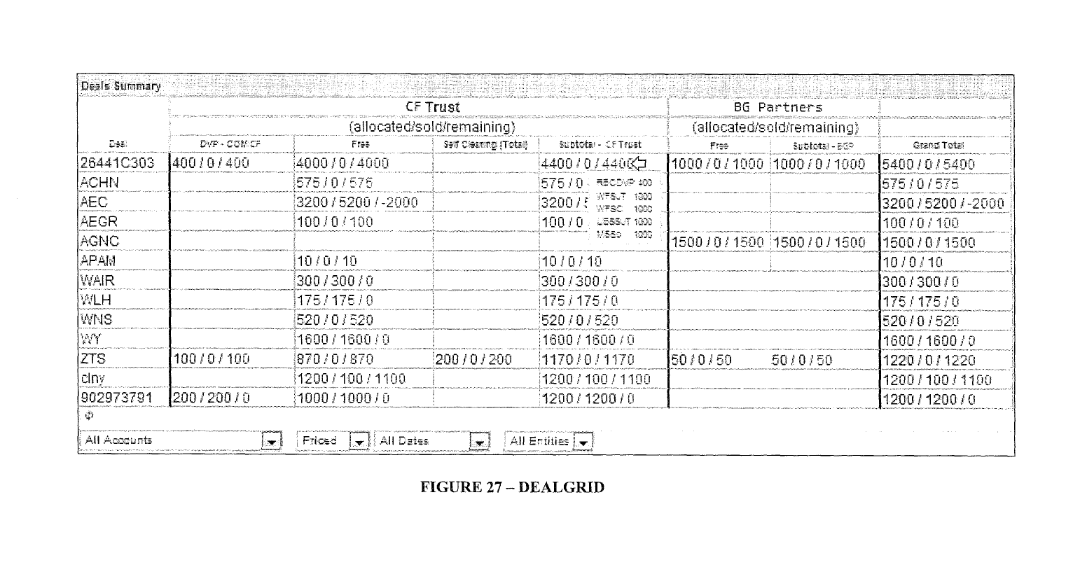

A typical “free-delivery” transaction and its entry into AccounTrex would go as follows (for illustration purposes, it is assumed that the sale occurs on the same day as the buy):
1) MSFT Announces a Secondary Stock Offering deal. It happens to be that 4000 Shares of MSFT were previously purchased and have been in the Trader's portfolio for 6 months before this Secondary offering was announced. Those shares appear as open positions in the Dashboard's Open Positions screen. Even so, the Trader studies the deal and decides that additional shares should be acquired in the offering—to be sold for a quick profit.
2) As with all stock offerings, AccounTrex downloads the MSFT deal information (Key prospectus information, such as date of deal announcement, Symbol, Shares to be offered, Underwriters offering the shares) from a data provider, including the list of underwriters in the selling syndicate. The Trader accesses the Deal Blotter, and selects the new MSFT deal for addition to the Allocations Blotter. Alternately, the Trader manually enters the deal information in the “Deals” section of the “Blotters” screen (See FIG. 1), and selects the new MSFT deal for addition to the Allocations Blotter.
3) A list is automatically generated in the Allocations Blotter, providing spaces into which a trader can enter indications (subscriptions) and allocations of shares for the MSFT deal. A line appears for every account that the Trader owns at underwriting firms selling shares on the Deal (See FIG. 8).
4) Trader opens his Blotter screen to find the deal information, as well as a Blotter ready for recording actions relating to that information ready for use.
5) The trader calls his brokers at the underwriting firms to indicate for shares of the MSFT deal, entering the indication amount in the cell of the indications column to the right of the relevant account name. The name of the Trader entering the information appears in the ‘Updated By” column, and the date and time of the last update to the row is also recorded. In the “Status” column, the word “Indicated” appears.
6) Until the morning that the MSFT deal is priced to trade, the trader can adjust the indication amounts in the indications column. The number of changes to each indication cell is recorded in the “Update Count” column, and the last updated date and time change accordingly.
7) The deal is priced at $29 per share. On the day of the pricing, the Trader calls his brokers at the underwriting firms to find out the allocations of shares for the MSFT deal. The number of shares allocated from each broker are entered into the allocations column in the rows relevant to each broker. The “Status” field in each row with a non-blank “Allocations” field now reads “Allocated” (See FIG. 9).
8) The trader receives an assortment of allocations from different brokers, totaling 4000 shares of MSFT through the secondary offering, as follows: 1200 from UBS Demo, 1150 from JPM Demo, 500 from RBC Demo and 650 from MS Demo. The Trader now owns a total of 8000 shares: 4000 purchased at the offering price (See FIG. 10), in addition to the 4000 shares that have been owned since before the offering.
9) On the day of the secondary offering, the Trader accesses the DealGrid screen (See FIG. 27), which summarizes deal allocations per deal for all tax entities. In this way, on a day that many deals are priced, a trader can keep track of the total shares per deal per entity that have not yet been sold.
10) The Trader observes the price movements of the stock, and decides that it is time to sell some to his account DemBS. Not only does the trader decide to sell what he received on the stock offering, but he decides to lighten up on his prior position of 4000 shares, selling 500, while leaving 3500 in his portfolio. A phone call is placed, and the order is given to sell 4500 shares at $29.50.
11) The trader now enters the trade into the Trade Blotter directly, or via the DealGrid.
   a. Via the Trade Blotter: The Blotter screen is opened, and the Trader enters the following order information into the Trade Blotter Order Entry Screen (FIG. 11): Sell 4500 shares of MSFT at $29.50 per share at account x.
   b. Via the DealGrid: The Trader clicks an allocation to sell, and a Trade Blotter Order Entry Screen appears, pre populated and pre matched to the allocations that were summarized by the value that was clicked. The Trader enters the order price and selects the account at which the sale order was given. The share amount is changed from 4000 (the amount of offering shares allocated on the deal) to 4500.
12) A few minutes later the Trader's broker at DemBS calls back to inform the Trader that in fact the trade executed at the $29.50 price.
13) The Trader selects the relevant order row in the Trade Blotter, and selects “Edit”. The Order Entry screen reopens. The Trader enters the execution price into the Execution Price cell (FIG. 11).
14) If the initial trade was not automatically matched via the DealGrid, the trader then clicks on the “Match Trades” button in the Trade Entry screen, opening the Match Trades screen (See FIG. 12). This screen allows the Trader to record which owned lots of MSFT were sold at this time, whether the lots are from the newly allocated shares, from other shares bought and entered into the Trade Blotter, or from the older shares that were in the Ledger. (If the trade was entered via the DealGrid, only the extra lot of 500 from the Ledger needs to be matched at this point, as the rest was matched earlier, automatically). This information contributes to AccounTrex's Acceptance Rules matching algorithm. Once the Quantity of Shares to Match field is filled in for the relevant buy lots, the Trader saves the new information by pressing OK. The saved trade appears in the Trade Blotter (See FIG. 13).
15) The next day, AccounTrex automatically logs into the Trader's brokerage accounts and downloads confirmed transaction data for the previous day's trades (including the MSFT allocations of 4000 shares and the sale trade of 4500 shares), stock and money transfers, or any other fees or credits.
   In each account's setup page (see FIG. 14), the Trader has already entered the user name and password of that account's web access. AccounTrex uses that login information to automatically download transaction data. While transaction data can always be manually entered into the Ledger, it is better to use downloaded data since it save a lot of time, and it is more accurate. AccounTrex's data download can happen either on a scheduled basis (such as Mon-Sat, 7 pm and 8 am), or upon initiation by the Trader.
16) After Accountrex determines that the downloaded MSFT Buy trades are new and not duplicates of old or current trades (in that they do not match by symbol, date proximity (set to 30 days by default), or value with any other trade in its database) a Transaction Group Identification Number is automatically assigned to each Trade.
17) Based on the Trade Matching that took place in step 13, AccounTrex determines that the new MSFT sale trade is relevant to both the more recently purchased shares, as well as 500 of the shares purchased at a much earlier date. The sale will be split automatically between the two transaction groups based on the Trader's matching input, entered into the Trade Blotter on the previous day. Alternatively, if the downloaded sale data is accepted manually, the trader can manually split the sale, regardless of whether or not the trades were matched beforehand.
18) The day's downloaded transaction data appears in the “Downloaded Data Screen”, which can be toggled to appear just below the “Ledger” screen. The downloaded data includes stock trades and deliveries, as well as any money transfers that took place in any of the Trader's accounts on the previous day. It is in this screen that the previous day's MSFT trades appear after they are downloaded, with new automatically assigned Transaction Group IDs (in the “Group Status” column). The Trader reviews the newly downloaded data for accuracy or inconsistency (See FIG. 15).
19) The newly downloaded trades must be accepted by the Trader into the transaction database. This can be done manually, or automatically using Automatic Data Acceptance Rules.
   a. Manual Acceptance is accomplished by checking a checkbox to the right of a downloaded transaction, and clicking the “+Accept” button at the bottom left of the Downloaded Data screen. Dialog boxes appear (See FIG. 16) in which the user selects matching trades for buys and sales, as well as counterparties for wires and securities transfers.
      For the sale that is relevant to two transaction groups, the trader selects the transaction groups that are relevant to the sale, as well as the share lots within those groups that were sold. The Sale is accepted into the Ledger as a split transaction.
   b. Automatic Data Acceptance is accomplished via Download Rules. Download Rules are automatic data processing routines that filter through and process the huge amounts of data downloaded from relevant brokerage and bank accounts on a daily basis. In addition to Rules for Automatic Data Acceptance, other Rule examples are: Delete extraneous data, Match trades before acceptance, Pair opposite sides of money transfers, Group monthly interest data from all brokers into one monthly “interest” group, etc. “System Rules” have complicated algorithms, proprietary to AccounTrex. “User Rules” can be created by Traders with custom criteria using AccounTrex's intuitive Rule Management interface.
      An example of System Rules are as follows:

Accept all cancels into the ledger for which the cancelled transaction is either in the ledger or the downloaded transactions. If the cancelled transaction is in the downloads, accept it along with the cancel and mark it as cancelled.

Accept all buys into the ledger unless there is an open short position for that security already in the ledger.

Accept all buys that are bought in the same account that they were sold in (or if both accounts clear DVP through the same account), and match the buy(s) to the sale(s).

When a sale and buy have been matched in the blotter, and subsequently that very same buy and sell are downloaded, accept them into the ledger and match them.

Accept all sales that are sold in the same account that they were purchased in (or if both accounts clear DVP through the same account), and match the sale(s) to the buy(s).

Deliver/Receive

If DVP—If exact number of shares purchased was delivered from account purchased in, and the account clears DVP, accept the deliver, set its Account 2 as the clearance account, accept it into the ledger, and match it to the buy.

If a matching receive is found within T+1 in the downloads, accept that too and match it to the buy.

Otherwise—If a delivery is expected from account A to account B (i.e. there is an undelivered position) . . .

If a deliver is downloaded from account A that matches the exact number of shares expected, and a receive is downloaded (or is already in the ledger) from account B that matches the deliver.

If there is only one such delivery is expected, and one deliver and one receive are downloaded (within T+1 of each other). Or if there are multiple such deliveries expected, and the exact number of delivers and receives have been downloaded that have been expected. Then set the Account 2 on all the delivers and receives, accept them into the ledger, and match them to the appropriate buys.

If multiple delivers are expected, and not all of the deliver/receive pairs have been downloaded, do not accept any of the transactions.

If a deliver from A is already in the ledger, and a receive is downloaded from account B that matches the deliver (within T+1). Then set the Account 2 on the receive, accept it into the ledger, and match it to the same buy that the deliver is matched to.

Wire—If two sides of a wire with the exact same gross are downloaded with transaction dates within T+1 of each other, and there are no other wires with the same amount during T+1. Set the Account 2 for both wires, and accept them into the database. If the wire transaction dates are within T+3 of a buy whose net is the same as the wire, put the wires in the same transaction group as the buy.

Wire Fee—For Triad and Merill Lynch wires, if a wire fee is found with the same transaction code as a wire in the ledger, put the fee in the same group as the wire.

Historical Rule for Securities—For securities that are 3 weeks old and still have not been accepted into the ledger, delete all delivers and receives. Accept all buys and sells and match them to each other FIFO.

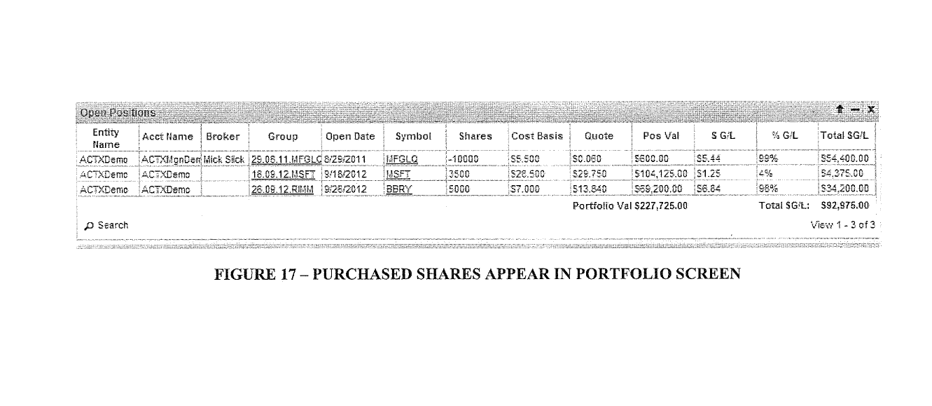

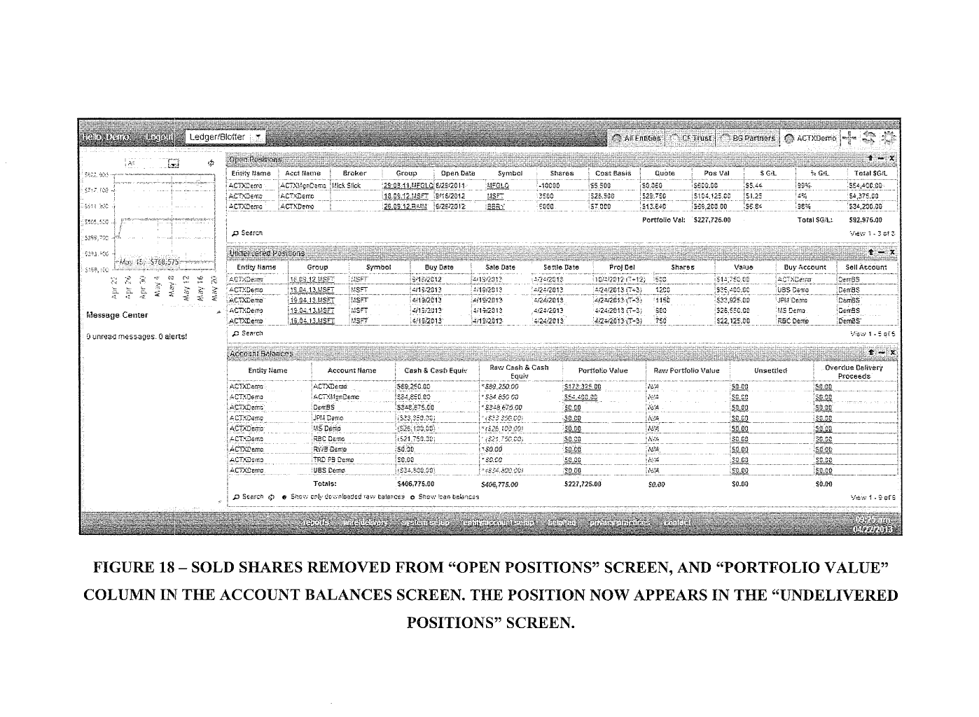

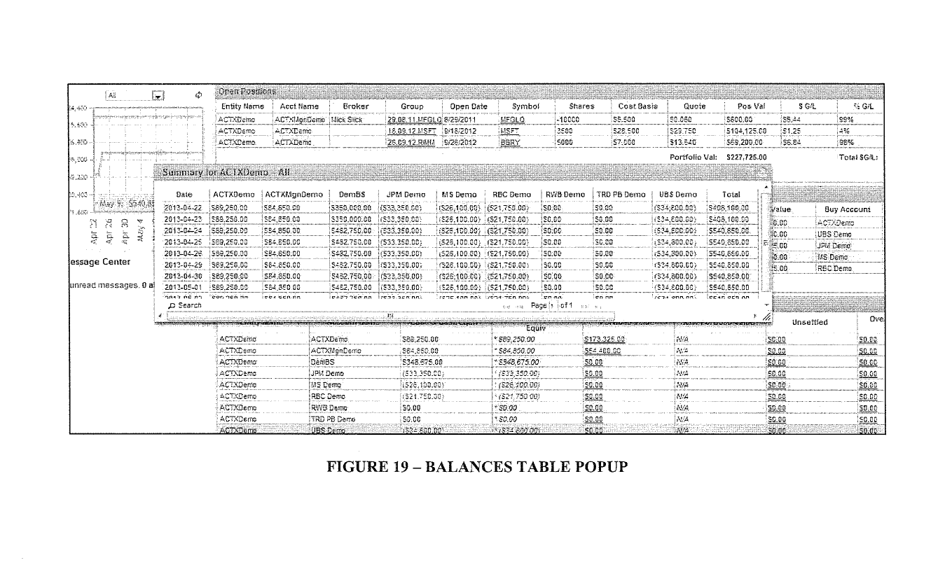

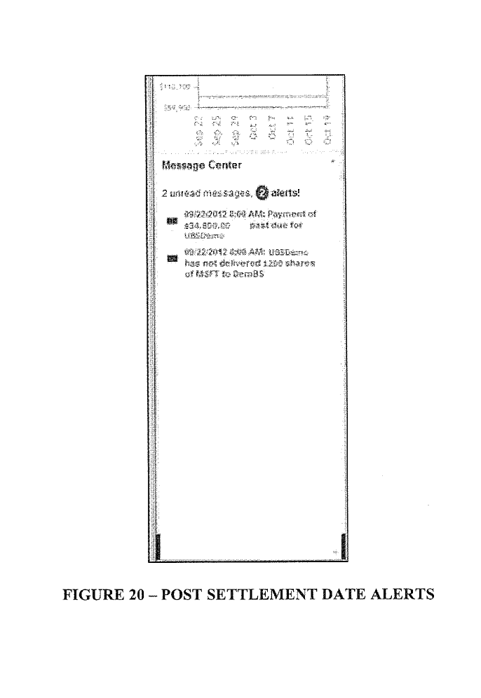

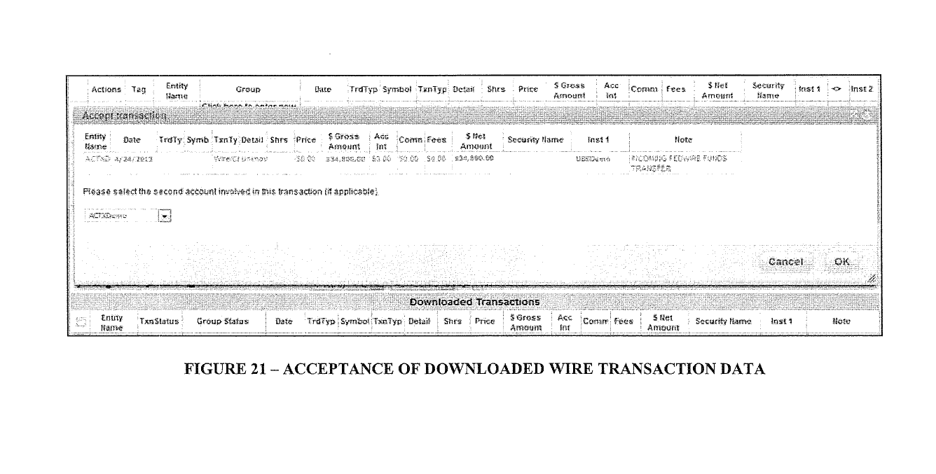

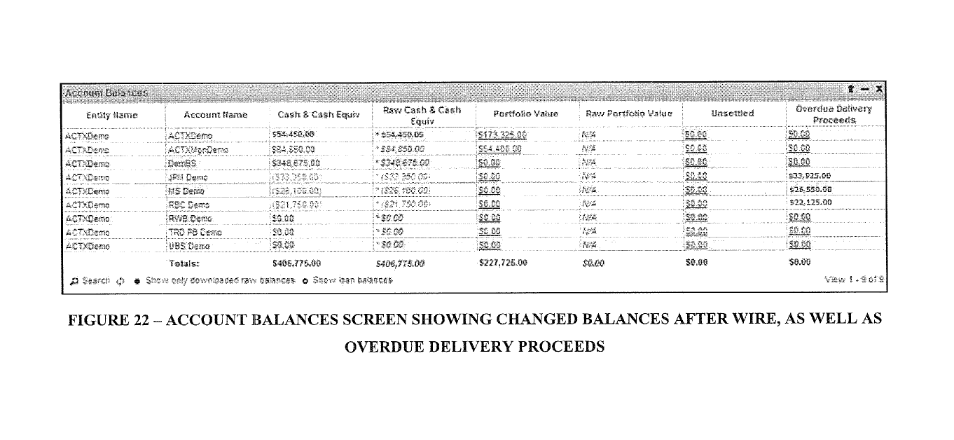

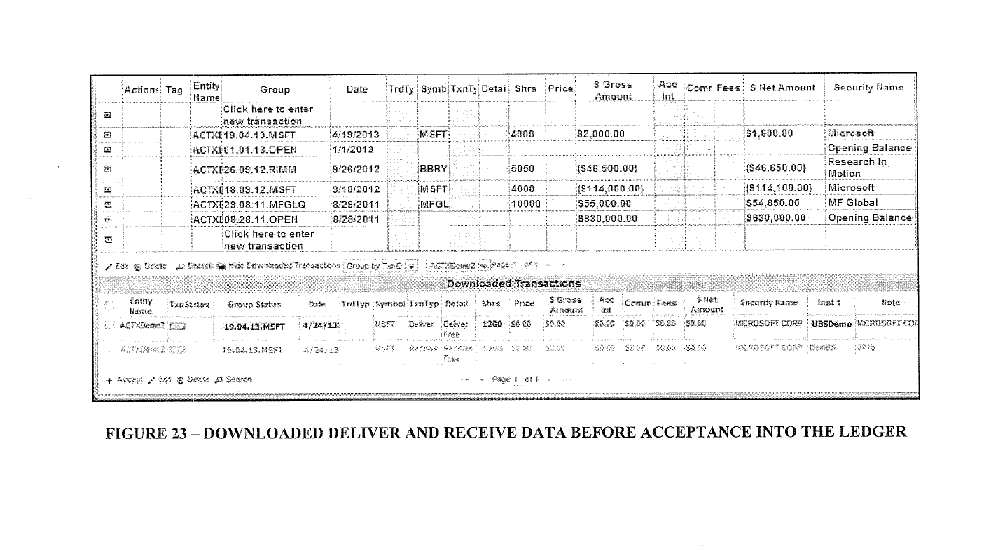

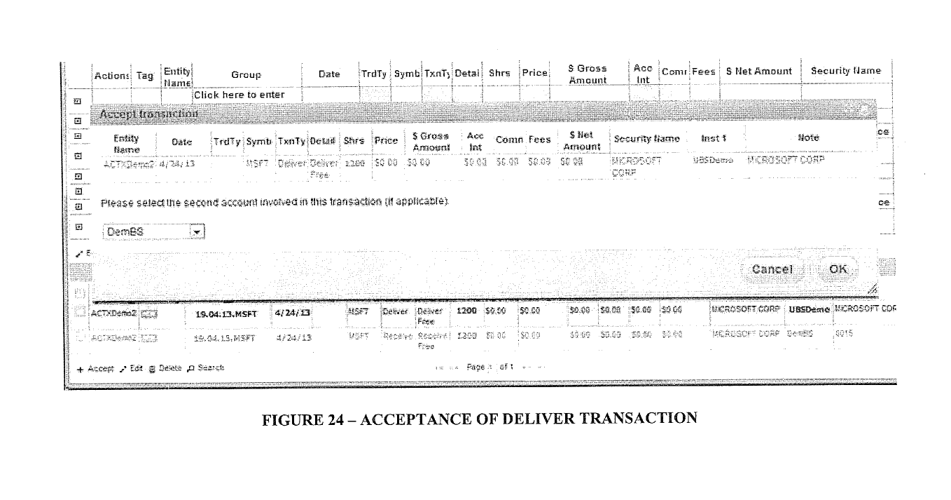

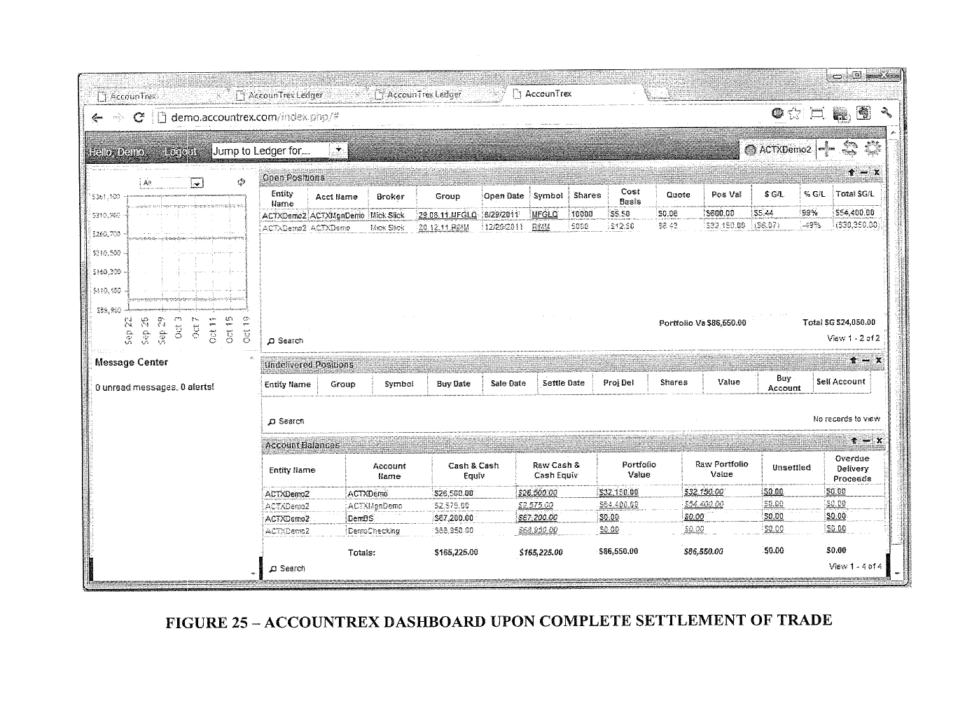

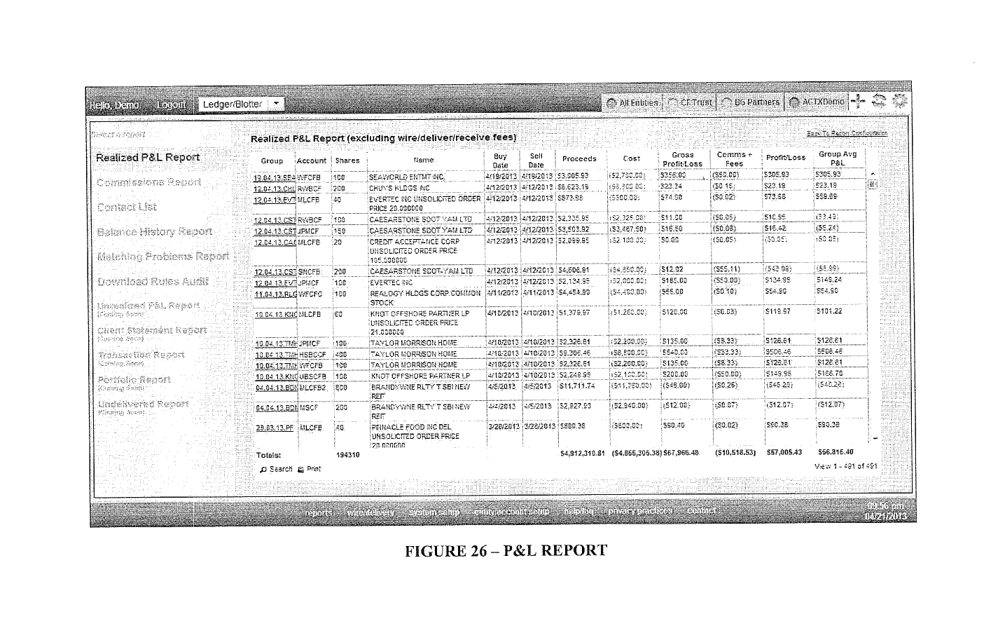

Historical Rule for Monetary Transactions—For Wire/Check, Debit/Credit, Taxable Interest, Fees, etc, that are 3 weeks old and still have not been accepted into the ledger, accept them all into the ledger and group them by month.
After reviewing the downloaded transaction, the user selects “Run Download Rules”, and the buy/sale transactions are automatically matched. Matching is augmented by separate algorithms that compare the downloaded data with information that has already been entered into the blotters. Receives and delivers are paired with counterparties (delivering and receiving brokers) in addition to being matched with their affiliated securities transactions. The Rules then automatically accept the processed transactions into the Ledger. The Sale is accepted into the Ledger as a split transaction.
20) Once transactions have been accepted into the Ledger, any additional information could be manually added to transaction entries, such as notes, executing broker name, etc.
21) In the “Open Positions” screen on AccounTrex's Dashboard, what used to be a 4000 share position of MSFT now is reduced to 3500 shares. The position row shows the original transaction group in which those shares were bought, with current price quote and position value (see FIG. 17). Transaction Group ID number is clickable to reveal transaction details, and security symbol is clickable to bring up a detailed security information page from a well-known financial website.
22) Now that Accountrex “knows” that a security delivery must occur to settle the trade, the Dashboard's “Undelivered Positions” screen shows that 4500 shares of MSFT are not yet delivered from the accounts the shares were bought from, or received by Broker DemBS—the account the shares were sold to (See FIG. 18). Buy lots that have passed their Projected Delivery Date (Buy date+delivery speed in days) are highlighted in red to indicate that their delivery is delayed and may require follow-up.
23) The “Cash & Cash Equivalents” column of the “Account Balances” screen reflects the changes in cash balance for each of the accounts (See FIG. 18).
   a. In accounts that shares were bought, cash balance goes down by purchase price until settlement date—when transaction is paid for, by either cash in account or money transfer.
   b. In accounts where shares were sold, the cash balance goes down by value of sale until the account/s receives the shares. This happens when shares that are not held in a brokerage account are sold there. In these cases, the brokerage firm reduces the cash availability of the account to account for the missing shares, until they are received into the account.
24) Also in the Dashboard (See the top left corner of FIG. 18), the Balances graph shows projected cash availability, by date. Until the accounts at which shares were bought have received money equal to the purchase amount, or the sale account “DemBS” has received the shares that were sold to it, cash availability will be lower. Once money has been received in the buy accounts, their balances rise accordingly. Likewise, when then shares have been received by “DemBS”, cash availability is replenished in that account by the amount of the sale proceeds, plus or minus any trade profit or loss.
   A trader is allowed to request that a broker deliver shares out of that broker's account and into another account at another firm, as long as the delivery takes place after settlement date—which is usually the third day after trade date (t+3). In practice, deliveries rarely occur on t+3, but rather can be delayed by days or weeks, depending on a few factors: Broker or Trader preference, Brokerage firm policy, branch office policy, technical glitches in the delivery, as well as other factors. The AccounTrex Balances graph displays the Trader's Projected Cash Availability based on historical brokerage account stock delivery speeds which are visible in those accounts' Setup Screens. These speeds could be manually entered by the Trader into each account's setup screen, or calculated automatically based on that account's average delivery time.
   Clicking any point on the Balances Graph pops up a table showing detailed daily cash projections for each account (See FIG. 19). In the “DemBS” and “Total” columns, between April 23, 2013-Apr. 24, 2013, the balances rise, due to sales proceeds being freed up for use as a result of stock being received.
25) Until the buy accounts have been paid for the purchase of shares, or Broker DemBS has received its shares, alerts are generated in the Dashboard's “Message Center” screen notifying the Trader that these things still need to be done (See FIG. 20). Email alerts are sent to Trader as well.
26) On settlement date, Trader is alerted to the fact that a wires have not yet been sent to the buy accounts in payment for the share purchases (See FIG. 20).
27) Trader wires payment to the buy Brokers to pay for the stock purchases. In our case, this is done from the trader's checking account, DemoChecking, These transactions are done by instructing the bank regarding payee details by either fax or email.
28) On the following day, as part of the daily download routine that takes place across all accounts setup for download, AccounTrex automatically logs into the Trader's accounts (bank, brokerage, etc.) and downloads transaction data. On this day, the downloaded data includes transaction data for the wires from the sending (DemoChecking) and receiving broker accounts.
29) In the “Ledger” screen, downloaded data is reviewed and accepted either manually by the Trader into the transaction database (See FIG. 21), or by Rules. If done manually, the Trader is prompted to select the account into/from which the wire is being sent. Any additional information could be added to transaction entry, such as notes, executing broker name, etc. Data can be edited manually at a later date.
30) In the “Cash & Cash Equivalents” column of the “Account Balances” screen, the Checking account's balance drops by the amount of the wire, while the buy accounts' cash balances rises by the same amount (See).
31) Since the Trader has paid for the share purchase, Alerts for unpaid wire or money transfer to broker ACTXDemo are automatically dismissed from the message center.
32) After settlement date, until shares are delivered from broker ACTXDemo to broker DemBS, the sale value of undelivered shares appear in the “Overdue Delivery” column of the Account Balances screen, indicating the degree to which that account is straining the Trader's inter-account cash availability.
   33) At some future point, the shares are delivered from broker ACTXDemo to broker DemBS. This could be on any day from settlement date and on.
34) Accountrex logs into the relevant accounts and downloads data showing the delivery of shares from broker ACTXDemo and for the receiver of shares by broker DemBS (See FIG. 23). (At times, the receive is not downloaded on the same day. This might indicate that a problem may exist. A few examples of problems are: the stock was credited to the wrong account, or that it was mistakenly bounced back to the delivering broker, or that the receiving brokerage firm has misplaced the stock. In this case, AccounTrex would generate a “Not Received” alert in the message center and by email. For illustration purposes, however, it will be assumed that the transfer went smoothly.)
35) Delivery and receive transactions are automatically assigned Group ID numbers, corresponding with the Transaction Group that related buys and sales have been associated with, pending Trader review and acceptance.
36) In the “Downloaded Data” screen, downloaded data is reviewed, and accepted either automatically or manually by the Trader into the transaction database. Either way, each delivery is matched to its corresponding purchase lot (by broker name, symbol, share amount, and Blotter Matching, where applicable). If related receive transactions have been downloaded as well, the delivery is then matched with them.
37) Upon transaction acceptance, the trader can double check the auto-match of this delivery or receive to each other and their corresponding buy. (In a situation with multiple deliveries, if the trader feels that the receive should be matched to another deliver in the internal buffer, he or she may correct the selection of the account into/from which these shares should be delivered/received. Any additional information could be added to the transaction entry, such as notes, executing broker name, etc. Data can also be edited manually at a later date (See FIG. 24).
38) Once the Deliver and Receive have been accepted into the database, the position is automatically removed from the “Undelivered Positions” Dashboard screen (See FIG. 25).
39) The time between trade settlement dates and actual stock delivery are automatically added to each account's delivery speed calculation algorithm. In this way, delivery speed is constantly fine-tuned for accuracy.
40) The “Cash & Cash Equivalents” column of the “Account Balances” Dashboard screen reflects the changes in cash balance for each of the accounts (See FIG. 25).
   a. The “Overdue Delivery” balance for ACTXDemo goes down by the sale value of the delivered shares.
   b. The Cash & Cash Equivalents balance for DemBS goes up by the value of the sale proceeds.
41) Balances Graph changes to reflect the new inter-account cash availability (See top left corner of FIG. 25).
42) Alerts relating to non-delivery of MSFT shares are automatically removed from the Message Center (See bottom left corner of FIG. 25).
43) The MSFT trade Ledger entries can be assigned multiple color and shape coded “User Tags” for any purpose, and P&L reports can be filtered by individual tags (FIG. 4).
44) Profit and Loss reports can be viewed in order to assess performance on any given date, or range of dates (FIG. 26). Reports can be limited to trades that have been accepted into the Ledger, or can be expanded to include blotter trades that have not yet been downloaded and accepted into the Ledger. Reports can be filtered by Account, Institution (Brokerage Firm), Security, or User Tags.
45) P&L Reports can be displayed in three ways: Grouped by Sell Lot, Grouped by Buy Lot (allows comparison of allocations of shares secondaries and IPOs by different accounts—See FIG. 26), and Grouped by Transaction Group (a more compact presentation than sale lot, which also shows P&L of combined strategies included in that group).
46) Transactions and Allocations that have been entered via AccounTrex-Trader are automatically tagged for that trader, allowing that fund's managerial staff to view individual trader P&L reports and comparative trader performance reports.

### AccounTrex Features & Benefits

AccounTrex is the only portfolio and back-office management system designed especially for delivery-intensive stock trading funds
The system interrelates a trading entity's activity across multiple cash brokerage accounts
Full maintenance and support for inter-account cash and security movements
Allows highly efficient back-office operations, even during peak activity
True presentation of account balances and portfolio holdings in the global context of a trading firm's business.
AccounTrEx data may be viewed globally or by separate managed entities
Allocation and Trading Blotters ensure ease execution, while ensuring data consistency and accurate transaction matching

### Dashboard Features

The Open Positions, Undelivered Positions, and Account Balances screens give a true & current picture of holdings, workflow progress and hot operational issues
Each row can be clicked to show a pop-up displaying more detail regarding the transaction in question.
Predictive post-settlement cash-availability graph allows position building and new offering subscriptions to proceed with confidence
Cash Availability Tabular display makes it a breeze to efficiently balance accounts in order to meet account maintenance requirements.
The Alert Center reveals anomalies such as delayed or botched money or security transfers, unknown transactions & higher-than-negotiated transaction fees (in development).

### Ledger Features

Data is downloaded and accepted automatically in the main Ledger
Data editing and manual data entry, if needed
Data can be filtered and searched, globally or by separate tax entity
“Grouped Mode” enables viewing data by “deal” or strategy (ie: A secondary offering and relevant put options, receives, delivers, wires, etc.)
   Downloaded Transactions screen Features
All relevant brokerage and bank account data are downloaded from those institutions and matched with known transactions
Newly downloaded transactions are automatically matched with previously entered groups and transactions, based on date proximity, symbol, broker and share amount
In this way, broker errors are quickly resolved, odd fees are never overlooked, and the Ledger's data always reflects reality.
Download Rules enable automatic acceptance of downloaded transaction data into Ledger

### Blotter Screen Features

Timely and accurate display of deal information
Contextual indication worksheets ensure indication coverage of all accounts relevant to a deal
Customizable Tree structure summarizes allocations data
Trade Blotter Matching augments the efficiency of the Dowload Rules
Upload DVP trades and allocations straight from the Blotters to Prime Broker

### AccounTrex's Reporting Features

AccounTrex provides the following standard reporting capabilities:
Scope Key: G=Global A=Per account E=Tax Entity S=Security
Total P&L (G,A,E,S)
Long Term P&L (G,A,E,S)
Short Term P&L (G,A,E,S)
Income Earned (G,A,E,S)
Balance History (A)
Commissions/Fees Paid (G,A,E)
Undelivered/received (G,A,E,S)
Open Positions (G,A,E,S)
Cash Availability (G,A,E)
Dividends (G,A,E,S)

Contact Management Features

From the Dashboard, easily access:
Broker contact information
Recent account activity
Account specific settlement problem history

I claim:

1. A method substantially as described hereinabove.

2. A system substantially as described hereinabove.

3. A system substantially as illustrated in any of the drawings.
